(19) United States
(12) Patent Application Publication
(10) Pub. No.: US 2025/0232558 A1
(43) Pub. Date: Jul. 17, 2025

(54) ATTENTION-BASED THREE-DIMENSIONAL OBJECT DETECTION

(71) Applicant: QUALCOMM Incorporated, San Diego, CA (US)

(72) Inventors: Sanghyuk LEE, Seoul (KR); Youngsaeng JIN, Seoul (KR); Seok-Soo HONG, Seoul (KR); Soyeb Noormohammed NAGORI, San Diego, CA (US)

(21) Appl. No.: 18/791,196

(22) Filed: Jul. 31, 2024

Related U.S. Application Data
(60) Provisional application No. 63/621,501, filed on Jan. 16, 2024.

(51) Int. Cl. G06V 10/32; G06V 10/82; G06V 20/58; G06V 20/64

(52) U.S. Cl. CPC G06V 10/32; G06V 10/82; G06V 20/58; G06V 20/64

(57) ABSTRACT

Systems and techniques are described herein for attention-based object detection. For example, a computing device can process a key via a first rectified linear unit of an attention engine of a machine learning model to generate a first output. The computing device can process the first output via a first normalization layer of the attention engine to generate a second output. The computing device can compute a dot product based on the second output and a value to generate a third output. The computing device can process a query via a second rectified linear unit of the attention engine to generate a fourth output. The computing device can process the fourth output via a second normalization layer of the attention engine to generate a fifth output. The computing device can compute a dot product based on the third output and the fifth output to generate a sixth output.

### CROSS-REFERENCE TO RELATED APPLICATION

This application claims the benefit of U.S. Provisional Application No. 63/621,501, filed Jan. 16, 2024, which is hereby incorporated by reference, in its entirety and for all purposes.

### TECHNICAL FIELD

The present disclosure generally relates to object detection. For example, aspects of the present disclosure include systems and techniques that provide attention-based object detection using an attention engine or module with a rectified linear unit (ReLU) and a normalization component.

### BACKGROUND

Object detection can be used to identify an object in a scene or environment (e.g., from a digital image or a video frame of a video clip of the scene or environment). In some cases, object tracking can be used to track a detected object over time. Object detection and tracking can be used in different fields, including autonomous driving, video analytics, security systems, robotics, aviation, among many others. In some fields, an object can determine positions of other objects in an environment so that the object can accurately navigate through the environment (e.g., to make accurate motion planning and trajectory planning decisions). In some cases, the object may not expect other objects (e.g., static objects) when traversing through the environment. It can be important for the object to be able to detect such unexpected objects and to accurately navigate the space relative to such objects.

Examples of fields where an object needs to be able to determine the position and/or location of other objects include autonomous or semi-autonomous driving by autonomous or semi-autonomous driving systems (e.g., of autonomous or semi-autonomous vehicles), extended reality (XR) systems, autonomous or semi-autonomous navigation by a robotic system (e.g., an automated vacuum cleaner, an automated surgical device, etc.), aviation systems, among others. Using autonomous driving systems as an illustrative example, a requirement for autonomous driving is the ability of an autonomous vehicle to detect unexpected objects on a road and to accurately determine the extent of the drivable space on the road. For instance, some static objects on a road can appear unexpectedly as the vehicle is driving, such as obstacles near a construction zone, obstacles in the road, etc. Detection and/or tracking of unexpected objects can be difficult in some cases.

### SUMMARY

In one illustrative aspect, an apparatus is provided. The apparatus includes at least one memory and at least one processor coupled to at least one memory and configured to: process a key via a first rectified linear unit of an attention engine of a machine learning model to generate a first output; process the first output via a first normalization layer of the attention engine to generate a second output; compute a dot product based on the second output and a value to generate a third output; process a query via a second rectified linear unit of the attention engine to generate a fourth output; process the fourth output via a second normalization layer of the attention engine to generate a fifth output; and compute a dot product based on the third output and the fifth output to generate a sixth output.

In another illustrative aspect, a method is provided. The method includes: processing a key via a first rectified linear unit of an attention engine of a machine learning model to generate a first output; processing the first output via a first normalization layer of the attention engine to generate a second output; computing a dot product based on the second output and a value to generate a third output; processing a query via a second rectified linear unit of the attention engine to generate a fourth output; processing the fourth output via a second normalization layer of the attention engine to generate a fifth output; and computing a dot product based on the third output and the fifth output to generate a sixth output.

In another illustrative aspect, a non-transitory computer-readable storage medium is provided that includes instructions stored thereon which, when executed by at least one processor, causes the at least one processor to: process a key via a first rectified linear unit of an attention engine of a machine learning model to generate a first output; process the first output via a first normalization layer of the attention engine to generate a second output; compute a dot product based on the second output and a value to generate a third output; process a query via a second rectified linear unit of the attention engine to generate a fourth output; process the fourth output via a second normalization layer of the attention engine to generate a fifth output; and compute a dot product based on the third output and the fifth output to generate a sixth output.

In another illustrative aspect, an apparatus is provided. The apparatus includes: means for processing a key via a first rectified linear unit of an attention engine of a machine learning model to generate a first output; processing the first output via a first normalization layer of the attention engine to generate a second output; means for computing a dot product based on the second output and a value to generate a third output; processing a query via a second rectified linear unit of the attention engine to generate a fourth output; means for processing the fourth output via a second normalization layer of the attention engine to generate a fifth output; and means for computing a dot product based on the third output and the fifth output to generate a sixth output.

In another illustrative aspect, an apparatus is provided. The apparatus includes at least one memory and at least one processor coupled to at least one memory and configured to: reduce, at a convolutional downsampling layer of an attention-based three-dimensional object detector, a size of features associated with an image to generate a first key and a first value; process, via a first attention engine, a second key, a second value, and a first query associated with object queries generated from the features to generate a second query; and process the first value, the first key, and the second query at a second attention engine to generate an output.

In another illustrative aspect, a method is provided. The method includes: reducing, at a convolutional downsampling layer of an attention-based three-dimensional object detector, a size of features associated with an image to generate a first key and a first value; processing, via a first attention engine, a second key, a second value, and a first query associated with object queries generated from the features to generate a second query; and processing the first value, the first key, and the second query at a second attention engine to generate an output.

In another illustrative aspect, a non-transitory computer-readable storage medium is provided that includes instructions stored thereon which, when executed by at least one processor, causes the at least one processor to: reduce, at a convolutional downsampling layer of an attention-based three-dimensional object detector, a size of features associated with an image to generate a first key and a first value; process, via a first attention engine, a second key, a second value, and a first query associated with object queries generated from the features to generate a second query; and process the first value, the first key, and the second query at a second attention engine to generate an output.

In another illustrative aspect, an apparatus is provided. The apparatus includes: means for reducing, at a convolutional downsampling layer of an attention-based three-dimensional object detector, a size of features associated with an image to generate a first key and a first value; means for processing, via a first attention engine, a second key, a second value, and a first query associated with object queries generated from the features to generate a second query; and means for processing the first value, the first key, and the second query at a second attention engine to generate an output.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example of camera views and bird's eye views (BEVs), according to aspects of the disclosure;

FIG. 2 is a diagram illustrating an example attention engine, according to aspects of the disclosure;

FIG. 3 is a diagram illustrating the attention process, according to aspects of the disclosure;

FIG. 4 is a diagram illustrating an example of a linformer which approximates a lower-rank matrix, according to aspects of the disclosure;

FIG. 5 is a diagram illustrating an example of efficient attention, according to aspects of the disclosure;

FIG. 6A is a diagram illustrating an example of a system using a convformer as part of one or more attention engines, according to aspects of the disclosure;

FIG. 6B is a diagram illustrating an example of a combination of a self-attention module and a cross-attention engine, according to aspects of the disclosure;

FIGS. 7A and 7B illustrate example processes for performing operations according to the systems and techniques described herein, according to aspects of the disclosure; and

FIG. 8 is a diagram illustrating an example of a computing system, according to aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

As noted previously, object detection can be used to identify an object in a scene or environment (e.g., from a digital image or a video frame of a video clip of the scene or environment). In some cases, three-dimensional (3D) object detection can be performed to detect objects in a 3D scene. In some cases, an attention-based object detector (e.g., TransFusion) can be used to perform 3D object detection. An attention-based object detector utilizes one or more attention mechanisms, such as self-attention and/or cross-attention. Although attention mechanisms are notorious for heavy memory consumption and computation cost, attention mechanisms may be preferred over convolutional neural networks (CNN) due to better accuracy of the attention mechanisms.

However, it can be difficult to run attention mechanisms on certain memory and/or compute-constrained devices, such as edge devices/nodes (e.g., mobile devices, XR devices, etc.) or other compute devices. Furthermore, it can be inefficient to run attention mechanisms on certain computer chips, due to the heavy computation requirements of attention mechanisms.

The large computation and memory cost of attention mechanisms is due, at least in part, to cross-attention calculations (e.g., which are used in many attention-based object detectors) and also due to the use of Softmax layers or functions. A Softmax layer/function is an activation function that scales numbers or logits into probabilities. The output of a Softmax layer/function is a vector (e.g., a vector v) with probabilities of each possible outcome. The probabilities in the vector output by the Softmax layer/function sums to one for all possible outcomes or classes.

In some aspects, a bird's eye view (BEV) image can be used by a 3D object detector when performed 3D object detection. For example, features can be extracted from a BEV image (e.g., by a feature extraction layer or backbone of a neural network model) and the features can be processed by an attention-based detector (e.g., including self-attention, cross-attention, Softmax layers/functions, and/or dot product functions). In the case of cross-attention, an entire size of BEV feature is typically input into the attention-based detector as a key and value, which results in makes performing the dot product functions computationally intensive. Furthermore, attention-based detectors use Softmax functions, which as noted above are not optimized well on many devices (e.g., edge devices or other devices that have limited resources), making it difficult to perform object detection using such techniques.

Some techniques (e.g., an Efficient Attention detector) approximate the original Softmax attention by interchanging computation order while reducing memory and computation cost. However, such techniques (including the Efficient Attention detector) can have issues due to the continued use of Softmax layers/functions, such as when processing larger input sizes.

Systems, apparatuses, electronic devices, methods (also referred to as processes), and computer-readable media (collectively referred to herein as “systems and techniques”) are described herein that provide attention-based object detection using an attention engine or module with a rectified linear unit (ReLU) and a normalization component. For example, instead of using Softmax layers/functions, an attention engine or module can include at least one ReLU function and at least one normalization layer or component. In some cases, an output of each ReLU layer/function can be processed by a normalization layer/component.

In some aspects, a downsampling layer can be included in the attention engine (e.g., prior to cross-attention) in order to reduce the size of features (e.g., BEV feature(s)). For example, the reduced-size features can be input to the cross-attention engine as a key and a value. In some cases, the downsampling layer can encode spatial information of the features (e.g., BEV feature(s)) into reduced-size features in order to reduce the size of the features processed by the cross-attention engine.

Such systems and techniques can allow an attention-based object detector to run on any type of computer chip and/or device, even resource-constrained devices (e.g., edge devices).

Various aspects of the application will be described with respect to the figures.

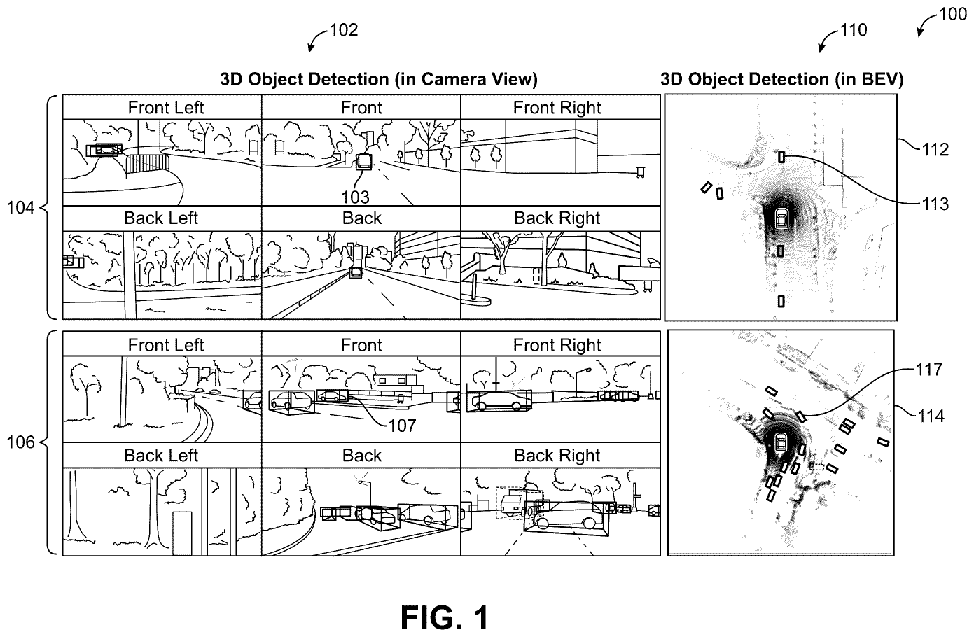

FIG. 1 is a diagram illustrating an example of 3D object detection results 100 in two-dimensional (2D) images 102 (also referred to as a “camera view”) and in bird's eye view (BEV) images 110. For example, the various 2D images 102 are shown with object detection results (illustrated as bounding boxes, including bounding box 103). The 2D images 102 include a first set of 2D images 104 and a first set of 2D images 106. The BEV images 110 are also shown with object detection results (illustrated as bounding boxes, including bounding box 111). The BEV images 110 include a first BEV image 112 and a second BEV image 114.

The 2D images 102 are captured by different cameras of one or more vehicles. The object detection results shown in the 2D images 102 correspond to the object detection results illustrated in the BEV images 110. For example, the first set of 2D images 104 are captured by a front-left camera, a front camera, a front-right camera, a back-left camera, a back camera, and a back-right camera of a vehicle. The various objects detected in the first set of 2D images 104 (as indicated by the bounding boxes) correspond to the objects detected in the first BEV image 112. For instance, the object represented by bounding box 103 in the image captured by the front camera of the vehicle corresponds to the object represented by the bounding box 113 in the BEV image 112.

Similarly, a second set of 2D images 106 are captured by a front-left camera, a front camera, a front-right camera, a back-left camera, a back camera, and a back-right camera of the vehicle (or another vehicle). The objects detected in the second set of 2D images 106 correspond to the objects detected in the BEV image 114. For example, the object represented by bounding box 107 in the image captured by the front camera of the vehicle corresponds to the object represented by the bounding box 117 in the BEV image 114.

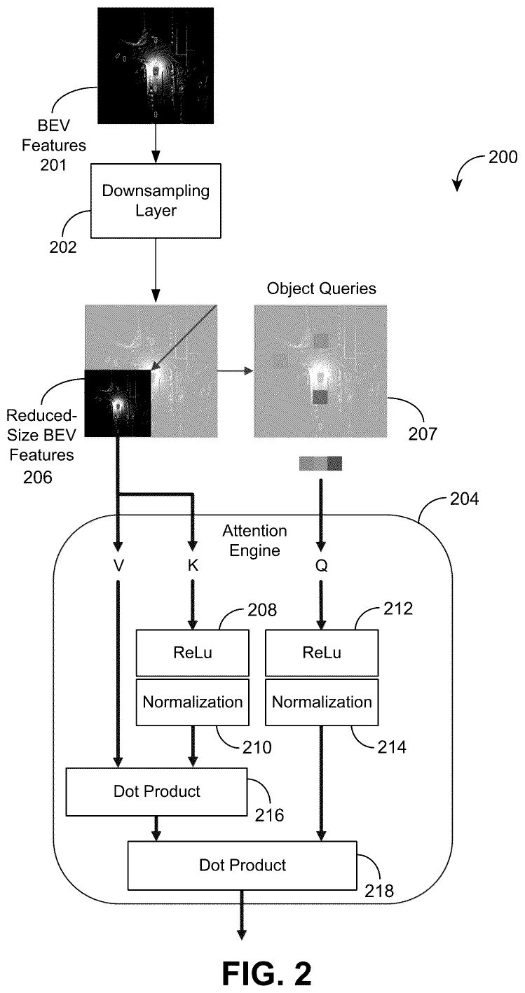

FIG. 2 is a diagram illustrating an example of a system 200 including a downsampling layer 202 and an attention engine 204, according to aspects of the disclosure. As described previously, the downsampling layer 202 can be included in the attention engine 204 prior to an attention function (e.g., a self-attention function and/or a cross-attention function). The downsampling layer 202 receives BEV feature(s) 201 as input. The BEV feature(s) 201 can include a feature vector (e.g., an embedding vector). In some cases, the BEV feature(s) 201 (e.g., the feature vector) can be generated by an encoder of a neural network model of the system 200. The downsampling layer 202 can reduce a size of the BEV feature(s) to generate reduced-size BEV feature(s) 206. For instance, the downsampling layer 202 can encode spatial information of the BEV feature(s) 201 into smaller sized feature(s) to generate reduced-size BEV feature(s) 206, reducing the computational cost in performing attention functions (e.g., self-attention and/or cross-attention) and/or dot-product functions. In some aspects, the downsampling layer 202 can include one or more convolutional layers that are configured to process the BEV feature(s) 201 using one or more convolutional kernels to reduce the size of the BEV feature(s) 201 to generate the reduced-size BEV feature(s) 206.

The reduced-size BEV feature(s) 206 can be input to the attention engine 204 as a key (K) and a value (V). In some cases, the attention engine 204 can be a cross-attention engine configured to perform cross-attention using the reduced-size BEV feature(s) 206 as the key K and the value V. As shown, the attention engine 204 can include rectified linear unit (ReLU) functions and normalization layers, including ReLU 208, normalization layer 210, ReLU 212, and normalization layer 214. The ReLU 208 is configured to process the key K from the reduced-size BEV feature(s) and output a result to the normalization layer 210. The normalization layer 210 can provide an output that is between 0 and 1, but at a much less computational cost as compared to a Softmax function. The output of the normalization layer 210 is processed by a dot product function 216.

The ReLU 212 is configured to process a query (Q) from a set of object queries 207. The set of object queries 207 can include potential or candidate 3D object detections. An output from the ReLU 212 can be processed by the normalization layer 214. An output of the normalization layer 214 and an output of the dot product function 216 can be processed by a dot product function 218. An output from the dot product function 218 is a feature or features (e.g., a feature vector) that can be provided to a downstream layer, such as a prediction head for object detection. In some cases, queries are vectors for which one wants to determine whether the queries relate to an object in an image. The keys and values can relate to other features (e.g., orientation data or other data) that have some information about the image. For example, a dot product can be used how to figure out how relative the key, values, and queries are to each other. The score output from the dot product can have a high value which can relate to the inputs being more relative to each other. If the score is a low value or close to zero, the inputs are not relative to each other.

The ReLU and normalization functions in the attention engine 204 can be used replace the Softmax function that is sometimes used in attention engines, without sacrificing any or a minimal amount of quality. The normalization performed by the normalization engine 210 and the normalization engine 214 can add a sum of each respective input vector's components based on an efficient attention approach. The Softmax function can normalize features (e.g., tensors). However, because ReLU functions do not normalize features (e.g., tensors), the normalization layer can be used perform a scaling normalization by dividing a vector with sum of its whole components. The optimization using ReLU and normalization, which can be referred to as FastTransFusion, can reduce the execution time of the detection head dramatically on a computer chip, while leading to marginal performance drops comparing to the original result.

In one illustrative example, assuming Q∈ [symbol] ^{n×d}^{ₖ}, K∈ [symbol] ^{nxd}^{ₖ}, the normalization (e.g., scaling normalization) can be performed as below:

$${ρ}_{q} ( Q ) = {D}_{q} ⊙ ReLU ( Q )$$

$${D}_{q} = [ \frac{1}{{d}_{ij}} ] ∈ {ℝ}^{n \times {d}_{k}} where {d}_{i j} = {\sum }_{m = 1}^{{d}_{k}} {ReLU ( Q )}_{im} ( i = 1 , … , n , j = 1 , … , {d}_{k} )$$

$${ρ}_{k} ( K ) = {D}_{k} ⊙ ReLU ( K )$$

$${D}_{q} = [ \frac{1}{{d}_{ij}} ] ∈ {ℝ}^{n \times {d}_{k}} where {d}_{i j} = {\sum }_{m = 1}^{n} {ReLU ( K )}_{mj} ( i = 1 , … , n , j = 1 , … , {d}_{k} )$$

$$O = {ρ}_{q} ( \frac{Q}{\sqrt{{d}_{k}}} ) ( {{ρ}_{k} ( \frac{K}{\sqrt{{d}_{k}}} )}^{T} V )$$

According to the above equations, Q is a matrix of values and D_{q} is a matrix of values that are equal to one divided a total sum (denoted as dᵢⱼ) of components (e.g., values) included a particular row of values of the matrix Q. One illustrative example of the matrix Q is as follows:

$$Q = [ \begin{matrix}1 & 2 & 3 \\ 2 & 2 & 2 \\ 3 & 3 & 3\end{matrix} ]$$

A sum of the first row of components (or values) of the matrix Q is equal to 6 (1+2+3=6). Similarly, a sum of the second row of components (or values) of the matrix Q equal to 6 (2+2+2=6). A sum of the second row of components (or values) of the matrix Q equal to 6 (3+3+3=9). Based on the sums of each row, the matrix D_{q} becomes one divided a total sum (denoted as dᵢⱼ) of the components (e.g., values) included in the corresponding row of values of the matrix Q, as follows:

$${D}_{q} = [ \begin{matrix}\frac{1}{6} & \frac{1}{6} & \frac{1}{6} \\ \frac{1}{6} & \frac{1}{6} & \frac{1}{6} \\ \frac{1}{9} & \frac{1}{9} & \frac{1}{9}\end{matrix} ]$$

The matrix Dg can then be multiplied with the matrix Q using element wise multiplication (denoted as ( ) as shown below:

$${D}_{q} ⊙ Q = [ \begin{matrix}\frac{1}{6} & \frac{2}{6} & \frac{3}{6} \\ \frac{2}{6} & \frac{2}{6} & \frac{2}{6} \\ \frac{3}{9} & \frac{3}{9} & \frac{3}{9}\end{matrix} ]$$

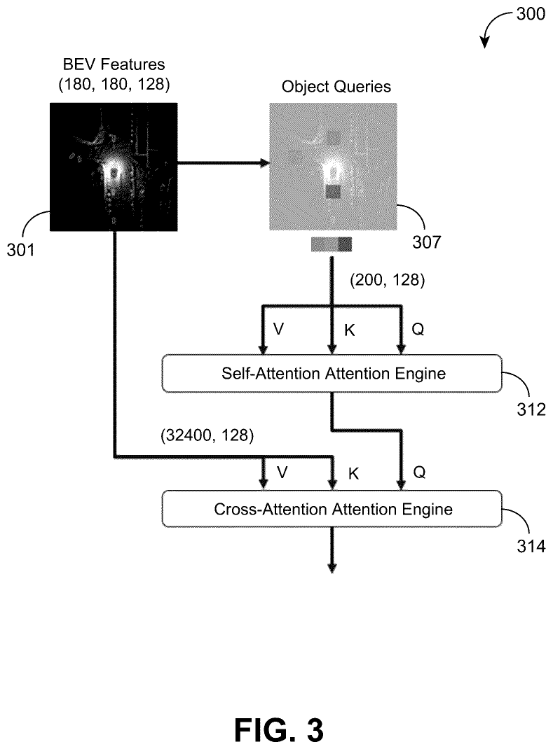

FIG. 3 is a diagram illustrating an example of a system 300 performing an attention process using attention engines, according to aspects of the disclosure. The attention engines include a self-attention engine 312 and a cross-attention engine 314. In some cases, the self-attention engine 312 and/or the cross-attention engine 314 can include the components of the attention engine 204 of FIG. 2. In one illustrative example, Q∈ [symbol] ^{n×d}^{ₖ}, K∈ [symbol] ^{n×d}^{ₖ}, V∈ [symbol] ^{n×d}^{ᵥ}, where n is the number of sequences, and dₖ and d_{y} are the dimension for key and value, respectively. In one aspect, the self-attention engine 312 and/or the cross-attention engine 314 first calculate the attention score using query (Q) and key (K). Then, the attention engine 312 and/or 314 applies the score to a value (V) by a dot-product. The self-attention engine 312 processes the value V, the key K, and the query Q from the object queries, and outputs a query Q for processing by the cross-attention engine 314. Cross-attention can be interpreted as fusing multi-source features since it calculates how relative the value and the query are to each other.

In this way, components that are more relational to the query Q would get higher values. As a result, the output O∈ [symbol] ^{n×d}^{ᵥ} becomes:

$$O = Softmax ( \frac{{QK}^{T}}{\sqrt{{d}_{k}}} ) V$$

In TransFusion, a sequence length of the BEV feature(s) is much larger than object queries (32400 vs 200). As a result of the disparity in size, the cross-attention engine 314 calculation takes the majority of time and memory cost.

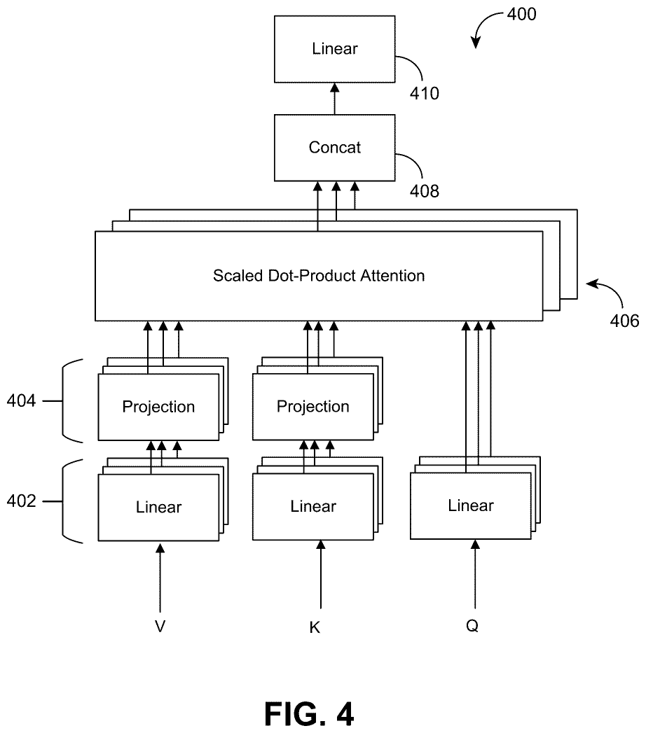

FIG. 4 is a diagram illustrating an example of a linformer 400 that can be used as an attention engine (e.g., the attention engine 312 and/or the attention engine 314 of FIG. 3), according to aspects of the disclosure. The linformer 400 approximates a low-rank matrix for both key (K) and value (V) using linear projection layers, including linear layers 402 and projection layers 404. For example, the weights of linear projection layers can be Eᵢ, Fᵢ∈ [symbol] ^{k×n}, respectively. In such an example, the linformer 400 can first project KWᵢ^{K}, VWᵢ^{v}∈ [symbol] ^{n×d} into EᵢKWᵢ^{K}, FᵢVWᵢ^{V}∈ [symbol] ^{k×d} dimensional matrices.

The output of a scaled dot-product attention layer 406 can be as follows:

$${O}_{i} = Attention ( {QW}_{i}^{Q} , {E}_{i} {KW}_{i}^{K} , {F}_{i} {VW}_{i}^{V} ) = softmax ( \frac{{{QW}_{i}^{Q} ( {E}_{i} {KW}_{i}^{K} )}^{T}}{\sqrt{{d}_{k}}} ) {F}_{i} {VW}_{i}^{V} ∈ {ℝ}^{n \times d}$$

The above operations only require O(nk) time and space complexity while softmax attention requires O(n²). If k<<n, the computation and memory complexity can be significantly reduced.

A concatenation operation 408 can be applied to the output of the output of the scaled dot-product attention layer 406. The output of the concatenation operation 408 can then be processed by an additional linear layer 410.

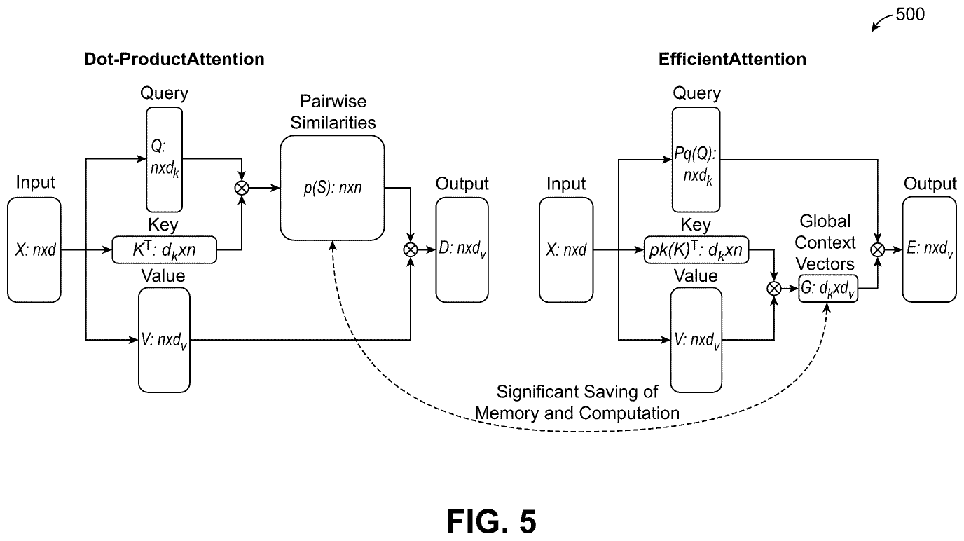

FIG. 5 is a diagram illustrating an example of efficient attention 500, according to aspects of the disclosure. When Q∈ [symbol] ^{n×d}^{ₖ}, K∈ [symbol] ^{n×d}^{ₖ}, V∈ [symbol] ^{n×d}^{ᵥ}, the result of dot-product attention is:

$$D ( Q , K , V ) = ρ ( {QK}^{T} ) V$$

The normalization function can be denoted as ρ(Y)=σ_{row}(Y), where Grow denotes applying the softmax function along each row of matrix Y. When β_{q}(Y)=σ_{row}(Y), ρₖ(Y)=σ_{col}(Y), the result of efficient attention is:

$$E ( Q , K , V ) = {ρ}_{q} ( Q ) ( {{ρ}_{k} ( K )}^{T} V )$$

As a result, the computation complexity reduces to [symbol] (d²n) from [symbol] (dₖn²) and memory complexity reduces to [symbol] (dn+d²) from [symbol] (n²).

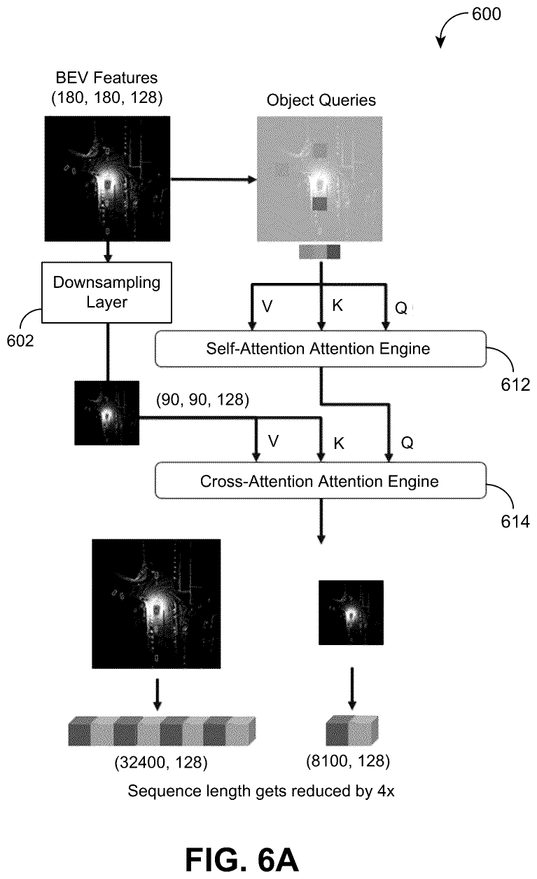

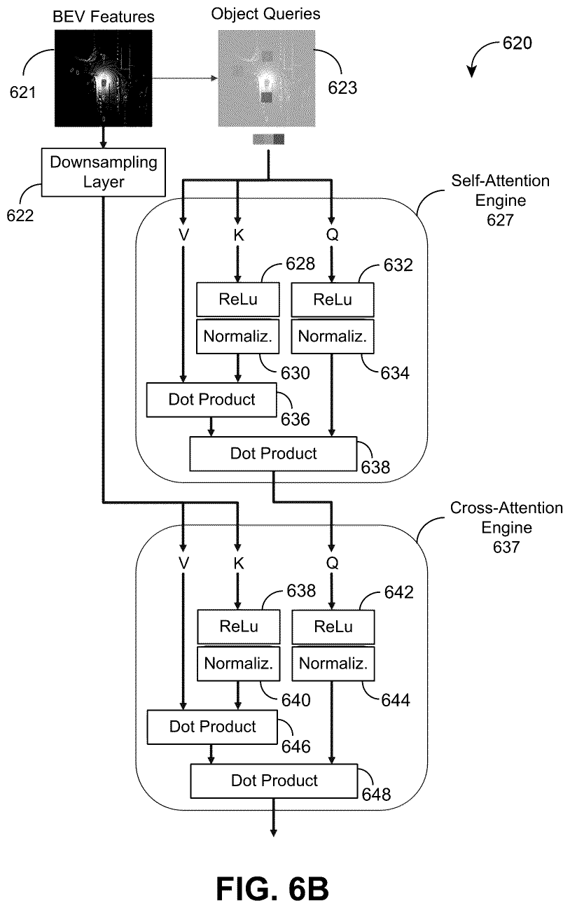

FIG. 6A is a diagram illustrating an example of a system 600 using a convformer as part of one or more attention engines, according to an aspect of this disclosure. The attention engines include a self-attention engine 612 and a cross-attention engine 614, which can be similar to and perform similar operations as the self-attention engine 312 and the cross-attention engine 314 of FIG. 3. In some cases, the self-attention engine 612 and/or the cross-attention engine 614 can include the components of the attention engine 204 of FIG. 2.

Similar to the system 200 of FIG. 2, the system 600 includes a downsampling layer 602. In some aspects, the downsampling layer 602 can be a convolutional downsampling layer (e.g., a convformer). The downsampling layer 602 can reduce the sequence length of BEV feature(s) in cross-attention. In some examples, the convolutional downsampling layer can include one convolutional layer (with a convolutional kernel size of 3, a stride of 2, and a padding of 1) and a ReLU function.

While linformer works globally, the downsampling layer 602 (e.g., convformer) may only encode locally peripheral BEV features. As a result, the downsampling layer 602 (e.g., convformer) can reduce by four times the amount of memory used (as compared to systems that utilize linformer) and can accelerate the model throughput.

FIG. 6B is a diagram illustrating an example of a system 620 including a combination of a self-attention engine 627 and a cross-attention engine 237, according to aspects of the disclosure. The system 620 including a downsampling layer 622. The downsampling layer 622 receives BEV feature(s) 621 as input. The BEV feature(s) 621 can include a feature vector (e.g., an embedding vector). For instance, the BEV feature(s) 621 (e.g., the feature vector) can be generated by an encoder of a neural network model of the system 620. The downsampling layer 622 can reduce a size of the BEV feature(s) 621 to generate reduced-size BEV feature(s) (not show), which can be similar to the reduced-size BEV feature(s) 206 of FIG. 2. For instance, the downsampling layer 622 can encode spatial information of the BEV feature(s) 621 into smaller sized feature(s) to generate reduced-size BEV feature(s), reducing the computational cost in performing attention functions (e.g., self-attention by the self-attention engine 627 and/or cross-attention by the cross-attention engine 637) and/or dot-product functions. In some aspects, the downsampling layer 622 can include one or more convolutional layers (e.g., convolutional downsampling layer) that are configured to process the BEV feature(s) 621 using one or more convolutional kernels to reduce the size of the BEV feature(s) 621 to generate the reduced-size BEV feature(s) 206. For instance, a convolutional layer can include one convolutional layer (with a convolutional kernel size of 3, a stride of 2, and a padding of 1) and a ReLU function.

As shown, the cross-attention engine 637 can include rectified linear unit (ReLU) functions and normalization layers, including ReLU 628, normalization layer 630, ReLU 632, and normalization layer 634. The ReLU 628 is configured to process a value (V) and a key (K) from a set of object queries 623 and output a result to the normalization layer 630. The set of object queries 623 can include potential or candidate 3D object detections. The normalization layer 630 can provide an output that is between 0 and 1. The output of the normalization layer 630 is processed by a dot product function 636.

The ReLU 632 is configured to process a query (Q) from the set of object queries 623. An output from the ReLU 632 can be processed by the normalization layer 634. An output of the normalization layer 634 and an output of the dot product function 636 can be processed by a dot product function 638. An output from the dot product function 638 is a feature or features (e.g., a feature vector).

The reduced-size BEV feature(s) from the downsampling layer 622 can be input to the cross-attention engine 637 as a key (K) and a value (V), in which case the cross-attention engine 637 can perform cross-attention using the reduced-size BEV feature(s) as the key K and the value V. The output from the dot product function 638 can be output to the cross-attention engine 637 as a query (Q). The cross-attention engine 637 can include rectified linear unit (ReLU) functions and normalization layers, including ReLU 638, normalization layer 640, ReLU 642, and normalization layer 644. The ReLU 638 is configured to process the key K from the reduced-size BEV feature(s) and output a result to the normalization layer 640. The normalization layer 640 can provide an output that is between 0 and 1 for processing by a dot product function 646.

The ReLU 642 can process the query (Q) from the dot product function 638. An output from the ReLU 642 can be processed by the normalization layer 644. An output of the normalization layer 644 and an output of the dot product function 646 can be processed by a dot product function 648. An output from the dot product function 648 is a feature or features (e.g., a feature vector) that can be provided to a downstream layer, such as a prediction head for object detection.

The optimization provided by the systems and techniques described herein can be performed on an object detection head, in which case the model (e.g., of the system 200 of FIG. 2, the system 600 of FIG. 6A, and/or the system 620 of FIG. 6B) can be attached to any other types of backbone neural network (e.g., for 3D object detection). In such cases, additional optimization is not needed when using such an object detection head in other methods. Multi-head attention can be used for deep neural networks in many areas. For example, in BEV perception, transformer-based networks are becoming more widely used. Among other uses, the systems and techniques described herein provide an attention-based 3D object detection head on certain chips without significant accuracy drop. 3D object detection neural networks can also be operated in an automotive system-on-chips (SOCs), allowing such SOCs to provide more efficient and powerful detection solutions. While examples are described herein using object detection for illustrative purposes, the systems and techniques can be used for any use case or architectures other than the object detection.

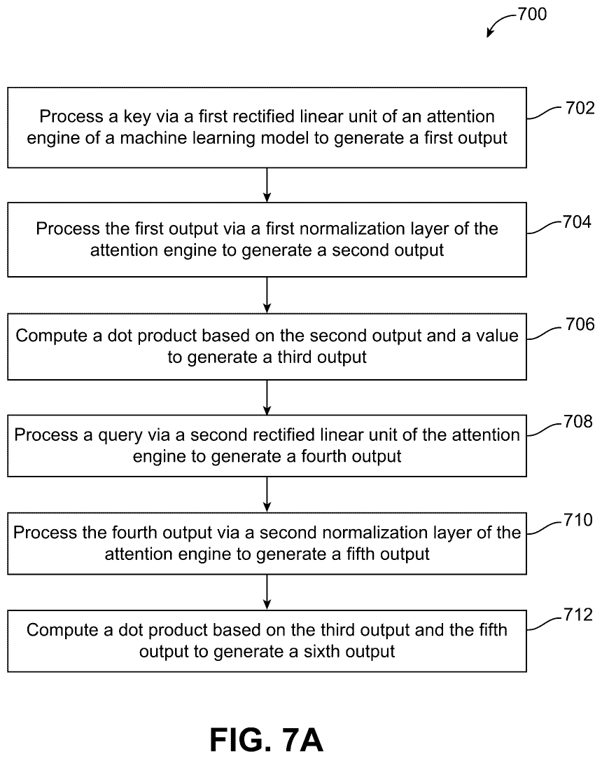

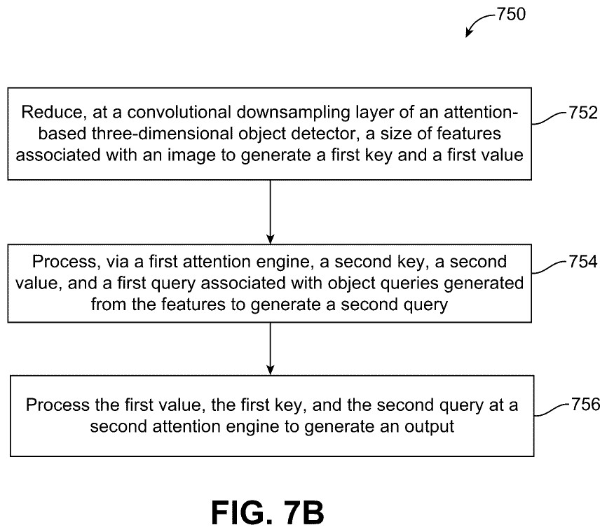

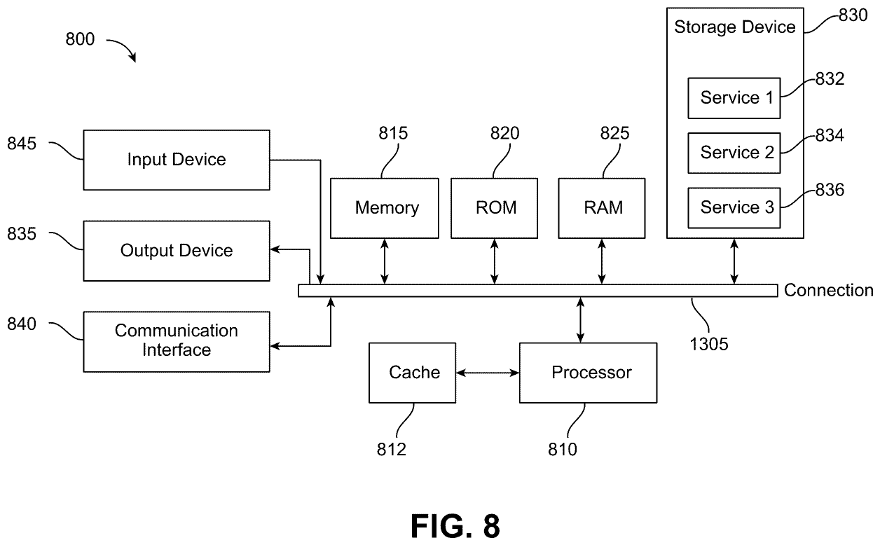

FIG. 7A illustrates an example process 700 for performing operations according to the systems and techniques described herein. For example, the process 700 may be used to perform object detection (e.g., three-dimensional object detection). The process 700 can be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., one or more machine learning systems or layer, component, or module thereof, any combination thereof, and/or other component or system) of the computing device or apparatus. In some cases, the computing device or apparatus (or component thereof) can include or can be a system including an attention engine as described herein (e.g., the system 200 of FIG. 2, the system 600 of FIG. 6A, the system 602 of FIG. 6B, or other attention engine), a computing system 800 according to FIG. 8) The operations of the process 800 may be implemented as software components that are executed and run on one or more processors (e.g., processor 810 of FIG. 8 or other processor(s)).

At block 702, the computing device (or component thereof) can process a key via a first rectified linear unit of an attention engine of a machine learning model (e.g., a neural network layer) to generate a first output. In some cases, the fourth output can include a set of positive values. In some aspects, the attention engine does not include a softmax function. For example, the first rectified linear unit conceptually replaces a Softmax function in the attention engine. In some aspects, the attention engine can include a cross-attention engine.

At block 704, the computing device (or component thereof) can process the first output via a first normalization layer of the attention engine to generate a second output. In some aspects, the computing device (or component thereof) can process the first output via the first normalization layer of the attention engine to generate the second output using a sum of each vector's components. For example, the first normalization layer can divide the vector with the sum of the vector components of the vector. In some aspects, processing the first output via the first normalization layer of the attention engine to generate the second output is further based on an efficient attention function as described herein.

At block 706, the computing device (or component thereof) can compute a dot product based on the second output and a value to generate a third output. In some cases, the key and the value are based on features. For example, the features can include bird's eye view (BEV) features (e.g., the BEV features or the reduced-size BEV features of FIG. 2) associated with a BEV image. In some aspects, the BEV features are generated from the BEV image using a feature extraction layer (e.g., a backbone) of the machine learning model. In some cases, the computing device (or component thereof) can reduce, at a downsampling layer of an attention-based three-dimensional object detector, a size of feature(s) associated with an image (e.g., BEV features, such as a feature vector, which can represent BEV input input) to generate the key and the value. In some aspects, the BEV feature represents BEV input from an earlier neural network layer. In some aspects, to reduce the size of the features, the computing device (or component thereof) can encode spatial information of the features (e.g., BEV features) into a smaller size (e.g., to generate the reduced-size BEV features of FIG. 2) relative to an original size of the features (e.g., the original BEV features, such as the BEV features of FIG. 2).

At block 708, the computing device (or component thereof) can process a query via a second rectified linear unit of the attention engine to generate a fourth output. In some cases, the fourth output can include a set of positive values.

At block 710, the computing device (or component thereof) can process the fourth output via a second normalization layer of the attention engine to generate a fifth output. In some aspects, the first normalization layer and/or the second normalization layer use the efficient attention techniques described herein to process respectively the first output or the fourth output. In some aspects, the first normalization layer and the second normalization layer divide a vector with a sum of vector components.

At block 714, the process 700 can include computing a dot product based on the third output and the fifth output to generate a sixth output. In some aspects, the sixth output can be used to perform objection detection. For instance, the sixth output can be used by the machine learning model (e.g., the neural network layer) to detect an object in the image. In some aspects, the sixth output can include features that are used by a prediction head to predict an object in the image.

The first output can include a set of positive values, such as, for example, values from 0 to 1 or some other positive range.

In some aspects, neither the first rectified linear unit of the attention engine nor the second rectified linear unit of the attention engine perform normalization.

FIG. 7B illustrates another example of a process 750 for performing operations according to the systems and techniques described herein. For example, the process 750 may be used to perform object detection (e.g., three-dimensional object detection). The process 700 can be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., one or more machine learning systems or layer, component, or module thereof, any combination thereof, and/or other component or system) of the computing device or apparatus. In some cases, the computing device or apparatus (or component thereof) can include or can be a system including an attention engine as described herein (e.g., the system 200 of FIG. 2, the system 600 of FIG. 6A, the system 602 of FIG. 6B, or other attention engine), a computing system 800 according to FIG. 8) The operations of the process 800 may be implemented as software components that are executed and run on one or more processors (e.g., processor 810 of FIG. 8 or other processor(s)).

At block 752, the process 750 included reducing, at a convolutional downsampling layer of an attention-based three-dimensional object detector, a size of features associated with an image to generate a first key and a first value. In some case, the features are BEV features associated with a BEV image (e.g., extracted from the BEV images using a feature extractor) In some aspects, the convolutional downsampling layer can include a convolutional layer (e.g., one convolutional layer) and a rectified linear unit. The convolutional downsampling layer further can include a kernel size of three, a stride of two and a padding of one.

In some aspects, the convolutional downsampling layer in some aspects only encodes locally peripheral features (e.g., BEV features). In some aspects, the first attention engine includes a self-attention engine and eth second attention engine includes a cross-attention engine.

At block 754, the process 750 includes processing, via a first attention engine, a second key, a second value and a first query associated with object queries generated from the BEV features to generate a second query.

At block 756, the process 750 includes processing the first value, the first key and the second query at a second attention engine to generate an output.

In some examples, as noted previously, the processes described herein (e.g., process 700 of FIG. 7A, process 750 of FIG. 7B, and/or other processes described herein) can be performed, in whole or in part, by a computing device or apparatus. In one example, one or more of the processes described herein can be performed by the system 200 of FIG. 2, the system 600 of FIG. 6, the system 602 of FIG. 6B, etc.

In another example, one or more of the processes (e.g., process 700 of FIG. 7A, process 750 of FIG. 7B, and/or other processes described herein) can be performed, in whole or in part, by the computing system 800 shown in FIG. 8. For instance, a computing device with the computing-device architecture of the computing system 800 of FIG. 8 can include, or be included in, the components of the system 200 of FIG. 2, the system 600 of FIG. 6, the system 602 of FIG. 6B, etc., and can implement the operations of process 800 of FIG. 8, and/or other processes described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of a device configured to perform the processes 700, 750 of FIGS. 7A-7B can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes 700, 750 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes 700, 750, methods and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a diagram illustrating a system for implementing certain aspects of the present technology. In particular, FIG. 8 illustrates a computing system 800, which can be any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

The system 800 includes at least one processing unit (CPU or processor) 810 and connection 805 that couples various system components including system memory 815, such as read-only memory (ROM) 820 and random-access memory (RAM) 825 to processor 810. Computing system 800 can include a cache 811 of high-speed memory connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fᵢ wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/long term evolution (LTE) cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 840 may also include one or more GNSS receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard and Visa (EMV) chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, the code causes the system to perform a function. In some aspects, a hardware service that performs a particular function can include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects provided herein. However, it will be understood by one of ordinary skill in the art that the aspects may be practiced without these specific details. For clarity of explanation, in some instances the present technology may be presented as including individual functional blocks including devices, device components, steps or routines in a method embodied in software, or combinations of hardware and software. Additional components may be used other than those shown in the figures and/or described herein. In some aspects, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, in some aspects, instructions and data which cause or otherwise configure a general-purpose computer, special purpose computer, or a processing device to perform a certain function or group of functions. Portions of computer resources used can be accessible over a network. The computer executable instructions may be, in some aspects, binaries, intermediate format instructions such as assembly language, firmware, source code. Examples of computer-readable media that may be used to store instructions, information used, and/or information created during methods according to described approaches include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, according to some aspects.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, in some aspects, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language in the disclosure reciting “at least one of” a set and/or “one or more” of a set indicates that one member of the set or multiple members of the set (in any combination) satisfy the claim. In some aspects, claim language reciting “at least one of A and B” or “at least one of A or B” means A, B, or A and B. In some aspects, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. In some aspects, claim language reciting “at least one of A and B” or “at least one of A or B” can mean A, B, or A and B, and can additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the aspects disclosed herein may be implemented as electronic hardware, computer software, firmware, or combinations thereof. To clearly illustrate the interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules, engines, or components may be implemented together in an integrated logic device or separately as discrete but interoperable logic devices. If implemented in software, then the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus comprising: at least one memory; and at least one processor coupled to at least one memory and configured to: process a key via a first rectified linear unit of an attention engine of a machine learning model to generate a first output; process the first output via a first normalization layer of the attention engine to generate a second output; compute a dot product based on the second output and a value to generate a third output; process a query via a second rectified linear unit of the attention engine to generate a fourth output; process the fourth output via a second normalization layer of the attention engine to generate a fifth output; and compute a dot product based on the third output and the fifth output to generate a sixth output.

Aspect 2. The apparatus of Aspect 1, wherein the first output comprises a set of positive values.

Aspect 3. The apparatus of Aspect 2, wherein the fourth output comprises a set of positive values.

Aspect 4. The apparatus of any one Aspects 1 to 3, wherein the attention engine does not include a softmax function.

Aspect 5. The apparatus of any one Aspects 1 to 4, wherein the sixth output is used by the machine learning model to detect an object in an image.

Aspect 6. The apparatus of any one Aspects 1 to 5, wherein the sixth output comprises features that are used by a prediction head to predict an object in an image.

Aspect 7. The apparatus of any one Aspects 1 to 6, wherein the key and the value are based on features.

Aspect 8. The apparatus of Aspect 7, wherein the features are bird's eye view (BEV) features associated with a BEV image.

Aspect 9. The apparatus of Aspect 8, wherein the BEV features are generated from the BEV image using a feature extraction layer of the machine learning model.

Aspect 10. The apparatus of any one Aspects 1 to 9, wherein at least one of the first normalization layer or the second normalization layer use efficient attention to process respectively the first output or the fourth output.

Aspect 11. The apparatus of any one Aspects 1 to 10, wherein the at least one processor is configured to process the first output via the first normalization layer of the attention engine to generate the second output using a sum of vector components of a vector.

Aspect 12. The apparatus of Aspect 11, wherein the first normalization layer is configured to divide the vector with the sum of the vector components of the vector.

Aspect 13. The apparatus of any one Aspects 1 to 12, wherein the attention engine comprises a cross-attention engine.

Aspect 14. The apparatus of any one Aspects 1 to 13, wherein the at least one processor is configured to reduce, at a downsampling layer of an attention-based three-dimensional object detector, a size of features associated with an image to generate a key and a value.

Aspect 15. The apparatus of Aspect 14, wherein, to reduce the size of the features, the at least one processor is configured to encode spatial information of the features into a smaller size relative to an original size of the features.

Aspect 16. A method comprising: processing a key via a first rectified linear unit of an attention engine of a machine learning model to generate a first output; processing the first output via a first normalization layer of the attention engine to generate a second output; computing a dot product based on the second output and a value to generate a third output; processing a query via a second rectified linear unit of the attention engine to generate a fourth output; processing the fourth output via a second normalization layer of the attention engine to generate a fifth output; and computing a dot product based on the third output and the fifth output to generate a sixth output.

Aspect 17. The method of Aspect 16, wherein the first output comprises a set of positive values.

Aspect 18. The method of Aspect 17, wherein the fourth output comprises a set of positive values.

Aspect 19. The method of any one Aspects 16 to 18, wherein the attention engine does not include a softmax function.

Aspect 20. The method of any one Aspects 16 to 19, further comprising detecting an object in an image using the sixth output.

Aspect 21. The method of any one Aspects 16 to 20, wherein the sixth output comprises features that are used by a prediction head to predict an object in an image.

Aspect 22. The method of any one Aspects 16 to 21, wherein the key and the value are based on features.

Aspect 23. The method of Aspect 22, wherein the features are bird's eye view (BEV) features associated with a BEV image.

Aspect 24. The method of Aspect 23, wherein the BEV features are generated from the BEV image using a feature extraction layer of the machine learning model.

Aspect 25. The method of any one Aspects 16 to 24, wherein at least one of the first normalization layer or the second normalization layer use efficient attention to process respectively the first output or the fourth output.

Aspect 26. The method of any one Aspects 16 to 25, further comprising processing the first output via the first normalization layer of the attention engine to generate the second output using a sum of vector components of a vector.

Aspect 27. The method of Aspect 26, wherein the first normalization layer is configured to divide the vector with the sum of the vector components of the vector.

Aspect 28. The method of any one Aspects 16 to 27, wherein the attention engine comprises a cross-attention engine.

Aspect 29. The method of any one Aspects 16 to 28, further comprising reducing, at a downsampling layer of an attention-based three-dimensional object detector, a size of features associated with an image to generate a key and a value.

Aspect 30. The method of Aspect 29, wherein reducing the size of the features comprises encoding spatial information of the features into a smaller size relative to an original size of the features.

Aspect 31. An apparatus comprising: at least one memory; and at least one processor coupled to at least one memory and configured to: reduce, at a convolutional downsampling layer of an attention-based three-dimensional object detector, a size of features associated with an image to generate a first key and a first value; process, via a first attention engine, a second key, a second value, and a first query associated with object queries generated from the features to generate a second query; and process the first value, the first key, and the second query at a second attention engine to generate an output.

Aspect 32. The apparatus of Aspect 31, wherein the convolutional downsampling layer comprises a convolutional layer and a rectified linear unit.

Aspect 33. The apparatus of Aspect 32, wherein the convolutional downsampling layer further comprises a kernel size of three, a stride of two, and a padding of one.

Aspect 34. The apparatus of any one Aspects 31 to 33, wherein the convolutional downsampling layer only encodes locally peripheral features.

Aspect 35. The apparatus of any one Aspects 31 to 34, wherein the first attention engine comprises a self-attention engine and eth second attention engine comprises a cross-attention engine.

Aspect 36. The apparatus of Aspect 35, wherein the features are bird's eye view (BEV) features associated with a BEV image.

Aspect 37. A method comprising: reducing, at a convolutional downsampling layer of an attention-based three-dimensional object detector, a size of features associated with an image to generate a first key and a first value; processing, via a first attention engine, a second key, a second value, and a first query associated with object queries generated from the features to generate a second query; and processing the first value, the first key, and the second query at a second attention engine to generate an output.

Aspect 38. The method of Aspect 37, wherein the convolutional downsampling layer comprises a convolutional layer and a rectified linear unit.

Aspect 39. The method of Aspect 38, wherein the convolutional downsampling layer further comprises a kernel size of three, a stride of two, and a padding of one.

Aspect 40. The method of any one Aspects 37 to 39, wherein the convolutional downsampling layer only encodes locally peripheral features.

Aspect 41. The method of any one Aspects 37 to 40, wherein the first attention engine comprises a self-attention engine and eth second attention engine comprises a cross-attention engine.

Aspect 42. The method of Aspect 41, wherein the features are bird's eye view (BEV) features associated with a BEV image.

Aspect 43. A non-transitory computer-readable storage medium comprising instructions stored thereon which, when executed by at least one processor, causes the at least one processor to perform operations according to any of Aspects 16-30.

Aspect 44. A non-transitory computer-readable storage medium comprising instructions stored thereon which, when executed by at least one processor, causes the at least one processor to perform operations according to any of Aspects 16-30.

Aspect 45. An apparatus comprising one or more means for performing operations according to any of Aspects 37-42.

Aspect 46. An apparatus comprising one or more means for performing operations according to any of Aspects 37-42.

What is claimed is:

1. An apparatus comprising:
at least one memory; and
at least one processor coupled to at least one memory and configured to:
process a key via a first rectified linear unit of an attention engine of a machine learning model to generate a first output;
process the first output via a first normalization layer of the attention engine to generate a second output;
compute a dot product based on the second output and a value to generate a third output;
process a query via a second rectified linear unit of the attention engine to generate a fourth output;
process the fourth output via a second normalization layer of the attention engine to generate a fifth output; and
compute a dot product based on the third output and the fifth output to generate a sixth output.

2. The apparatus of claim 1, wherein the first output comprises a set of positive values.

3. The apparatus of claim 2, wherein the fourth output comprises a set of positive values.

4. The apparatus of claim 1, wherein the attention engine does not include a softmax function.

5. The apparatus of claim 1, wherein the sixth output is used by the machine learning model to detect an object in an image.

6. The apparatus of claim 1, wherein the sixth output comprises features that are used by a prediction head to predict an object in an image.

7. The apparatus of claim 1, wherein the key and the value are based on features.

8. The apparatus of claim 7, wherein the features are bird's eye view (BEV) features associated with a BEV image.

9. The apparatus of claim 8, wherein the BEV features are generated from the BEV image using a feature extraction layer of the machine learning model.

10. The apparatus of claim 1, wherein at least one of the first normalization layer or the second normalization layer use efficient attention to process respectively the first output or the fourth output.

11. The apparatus of claim 1, wherein the at least one processor is configured to process the first output via the first normalization layer of the attention engine to generate the second output using a sum of vector components of a vector.

12. The apparatus of claim 11, wherein the first normalization layer is configured to divide the vector with the sum of the vector components of the vector.

13. The apparatus of claim 1, wherein the attention engine comprises a cross-attention engine.

14. The apparatus of claim 1, wherein the at least one processor is configured to reduce, at a downsampling layer of an attention-based three-dimensional object detector, a size of features associated with an image to generate a key and a value.

15. The apparatus of claim 14, wherein, to reduce the size of the features, the at least one processor is configured to encode spatial information of the features into a smaller size relative to an original size of the features.

16. A method comprising:
processing a key via a first rectified linear unit of an attention engine of a machine learning model to generate a first output;
processing the first output via a first normalization layer of the attention engine to generate a second output;
computing a dot product based on the second output and a value to generate a third output;
processing a query via a second rectified linear unit of the attention engine to generate a fourth output;
processing the fourth output via a second normalization layer of the attention engine to generate a fifth output; and
computing a dot product based on the third output and the fifth output to generate a sixth output.

17. The method of claim 16, wherein the first output comprises a set of positive values.

18. The method of claim 17, wherein the fourth output comprises a set of positive values.

19. The method of claim 16, wherein the attention engine does not include a softmax function.

20. The method of claim 16, further comprising detecting an object in an image using the sixth output.
